(19) United States
(12) Patent Application Publication
(10) Pub. No.: US 2021/0304344 A1
(43) Pub. Date: Sep. 30, 2021

(54) SYSTEM AND METHOD FOR DELIVERING PARCEL PACKAGES

(71) Applicant: Vincent Cheng, Burnaby (CA)

(72) Inventor: Vincent Cheng, Burnaby (CA)

(21) Appl. No.: 17/211,873

(22) Filed: Mar. 25, 2021

(30) Foreign Application Priority Data
Mar. 26, 2020 (CA) 3076807

(51) Int. Cl. G06Q 50/28; G06Q 10/08; G06Q 10/06; A47G 29/20

(52) U.S. Cl. CPC G06Q 50/28; A47G 29/20; G06Q 10/06311; G06Q 10/083

(57) ABSTRACT

A system for delivering parcel packages at doorsteps is provided that includes a package delivery management unit, a delivery vehicle network, and at least one gig-worker based computer network. The package delivery management unit sorts the parcel packages to be drop at a predetermined meeting junction by the delivery vehicle network including at least one delivery vehicle. Furthermore, the at least one gig-worker based computer network is communicably coupled to the delivery vehicle network to receive details related to the parcel packages; and to send the details related to the parcel packages on a plurality of computing devices associated to a plurality of parcel package receivers, based on a priority list. The parcel packages may be received by a priority parcel package receiver from the plurality of parcel package receivers defined on the priority list at the predetermined meeting junction.

The present disclosure relates to courier delivery, and, more particularly, to a system and a method for delivering parcel packages from delivery vehicles to customers.

### BACKGROUND OF THE DISCLOSURE

Delivery of packages especially in the “last mile” may be very expensive as it may take up to 40% of the total cost of the package delivery. The “last mile” refers to the part of the journey of the package from the customer's local courier warehouse to the customer's desired delivery location. The majority of the cost is from the driver labor cost and vehicle cost.

With the introduction of driverless delivery vehicles, the driver labor is dramatically reduced due to driver associated cost and walking the packages to the customer. However, with the driverless delivery vehicles, there may be a new problem, as the deliver the package up to the desired location of the customer becomes cumbersome due to absence of the driver who also act as delivery boy as there is no one to walking the package from the driverless delivery vehicle to the customer's desired location.

To obviate such problem, robots or drones may be used to deliver the packages, however, involvement of such robots or drones may make the whole delivery process even more costly and still would be as effective as it may require to be, due to the fact the such robots or drones may face many difficulties in delivering the package, for example, finding the package in the driverless delivery vehicles, finding the address of the customers, safety issue with regard to pouch pirates, cost of the robot and time to implement the program. Robots or drones may be feasible in the distant future but may not be happen for a while.

Further, human couriers and driverless couriers face many problems while making delivery accepts one of the biggest problems for them is entering gated communities, entry limited buildings like high rises buildings. On top of that, the driverless delivery vehicles largest barrier to feasibility of being use as a regular delivery method is getting the mail parcel packages from the back of the driverless delivery vehicle and to delivery of the package to the customers door cost effectitve and secure manner.

Accordingly, there exists a need to overcome shortcomings of the conventional delivery system. For example, there exists a delivery system and method that may not have to face problems while making delivery accepts in gated communities or in entry-limited buildings like high rises buildings. Further, there exists a delivery system and method which may enable the delivery vehicles with or without driver in getting the mail parcel packages from the back of the delivery vehicle and to delivery of the package to the customers door cost effectitve and secure manner.

### SUMMARY OF THE DISCLOSURE

In view of the foregoing disadvantages inherent in the prior art, the general purpose of the present disclosure is to provide a system and a method for delivering parcel packages, to include all advantages of the prior art, and to overcome the drawbacks inherent in the prior art.

An object of the present disclosure is to provide a system and a method for delivering parcel packages which may enable delivery of the packages in gated communities or in entry-limited buildings like high rises buildings.

An object of the present disclosure is to provide a system and a method for delivering parcel packages which may enable the delivery vehicles with or without driver in getting the mail parcel packages from the back of the delivery vehicle and to delivery of the package to the customers door cost effectitve and secure manner.

In light of the above objects, in one aspect of the present disclosure, a system for delivering parcel packages at doorsteps is described. The system includes a package delivery management unit, a delivery vehicle network, and at least one gig-worker based computer network. The package delivery management unit may be adapted to sort the parcel packages by a corresponding zone based on corresponding route of the parcel packages. The package delivery management unit may define a predetermined meeting junction corresponding to the route of the parcel packages. Further, the delivery vehicle network may include at least one delivery vehicle. The at least one delivery vehicle may be adapted to receive the parcel packages from the corresponding zone based on the corresponding route of the parcel packages to drop the parcel packages at the predetermined meeting junction. The at least one delivery vehicle includes an authentication module. Furthermore, the at least one gig-worker based computer network is communicably coupled to the delivery vehicle network. The at least one gig-worker based computer network includes a plurality of computing devices and a gig-worker based management unit. The plurality of computing devices may be associated with a plurality of parcel package receivers. The plurality of computing devices may be categorized based the types of plurality of parcel package receivers, and wherein each of the plurality of computing devices comprises an identification module or the plurality of parcel package receivers is identifiable by the authentication module. Further, the gig-worker based management unit includes a priority defining and prioritizing module and a communication receiving and sending module. The priority defining and prioritizing module defining a priority list of the plurality of computing devices based on the type of the plurality of parcel package receivers. Further, the communication receiving and sending module is configured to the delivery vehicle network to receive details related to the parcel packages; and also configured to the plurality of computing devices to send the details related to the parcel packages on the plurality of computing devices based on the priority list. The parcel packages are received by a priority parcel package receiver from the plurality of parcel package receivers defined on the priority list at the predetermined meeting junction based on authentication by the authentication module to the identification module or to the plurality of parcel package receivers.

In light of the above objects, in one aspect of the present disclosure a method for delivering parcel packages at doorsteps is disclosed. The method includes: sorting parcel packages by a corresponding zone based on corresponding route of the parcel packages; predefining a predetermined meeting junction corresponding to the route of the parcel packages; receiving, by at least one delivery vehicle of a delivery vehicle network, the parcel packages from the corresponding zone based on the corresponding route of the parcel packages; receiving, by at least one gig-worker based computer network, regarding the details of the parcel packages about the corresponding route of the parcel packages, the at least one gig-worker based computer network having a plurality of computing devices associated with a plurality of parcel package receivers, and a gig-worker based management unit, wherein the gig-worker based management unit comprises a priority defining and prioritizing module, and a communication receiving and sending module; defining a priority list, by the priority defining and prioritizing module; sending, to the plurality of computing devices associated with a plurality of parcel package receivers, the details related to the parcel packages on the plurality of computing devices based on the priority list; authenticating, a priority parcel package receiver from the plurality of parcel package receivers defined on the priority list based on identifying the priority parcel package receiver; receiving the parcel packages, by the authenticated priority parcel package receiver defined on the priority list, from the at least one delivery vehicle at the predetermined meeting junction.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawing, in which:

FIG. 1 illustrates a system 1000 for delivering parcel packages, in accordance with an exemplary embodiment of the present disclosure;

FIG. 2 illustrates a system 1000 for delivering parcel packages, in accordance with another exemplary embodiment of the present disclosure;

FIG. 3 illustrates a system 1000 for delivering parcel packages, in accordance with yet another exemplary embodiment of the present disclosure;

FIG. 4 illustrates a flow chart of a method 2000 for delivering parcel packages, in accordance with an exemplary embodiment of the present disclosure;

FIG. 5 illustrates a block diagram illustrating a method 3000 for delivering parcel packages, in accordance with an exemplary embodiment of the present disclosure;

FIG. 6 illustrates a standard locker delivery where customer may pick up the parcel package from an autonomous driving locker truck with the standard single pin code, in accordance with an exemplary embodiment of the present disclosure;

FIG. 7 illustrates a double code verification-based delivery system where customer may pick up the parcel package from a driving locker truck with double code verification process, in accordance with an exemplary embodiment of the present disclosure;

FIG. 8 illustrates a double code verification-based delivery system of FIG. 7 along with the delivery of the parcel package to safe box, in accordance with an exemplary embodiment of the present disclosure;

FIG. 9 illustrates picking up and delivery of two package parcels by a gig walker with a gig pin number for the same customer, in accordance with an exemplary embodiment of the present disclosure;

FIG. 10 illustrates a gig walker with pin to pick up two parcel packages, such as a package A and a package B and deliver such packages, in accordance with an exemplary embodiment of the present disclosure;

FIG. 11 illustrates a scenario wherein a gig walker A and gig walker B both pick-ups and drop-offs package into the customers A's drop off safe, in accordance with an exemplary embodiment of the present disclosure;

FIG. 12 illustrates a manned courier delivery the present system, in accordance with an exemplary embodiment of the present disclosure; and

FIG. 13 illustrates return package pickup utilizing the present system, in accordance with an exemplary embodiment of the present disclosure.

Like reference numerals refer to like parts throughout the description of several views of the drawing.

### DETAILED DESCRIPTION OF THE DISCLOSURE

The exemplary embodiments described herein detail for illustrative purposes are subject to many variations in implementation. The present disclosure provides a system and a method for delivering parcel packages. It should be emphasized, however, that the present disclosure is not limited only to what is disclosed and extends to cover various alternation to valve core assembly. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced items.

The terms “having”, “comprising”, “including”, and variations thereof signify the presence of a component.

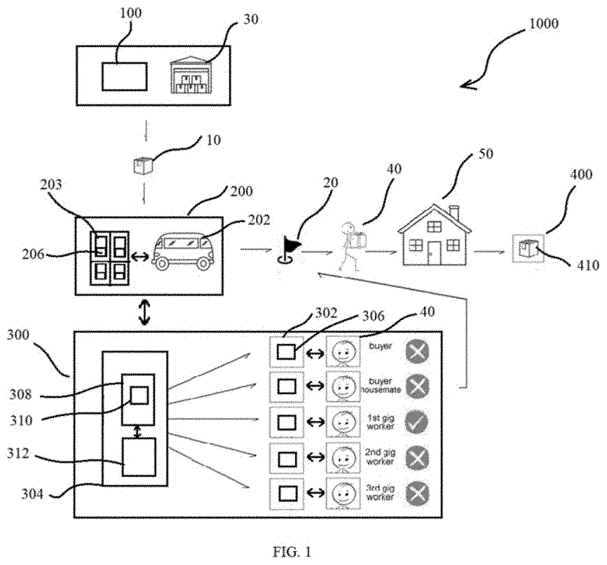

Referring now to FIG. 1, a system 1000 for delivering parcel packages 10 is illustrated in in accordance with another exemplary embodiment of the present disclosure. Embodiments of FIG. 1 is related to a system whereby a parcel package may be delivered from a driverless delivery vehicle to a door of the customers living in houses on in apartments. The purpose of the present disclosure is to provide such a system in which the parcel package received from a driverless delivery vehicle may be delivered to a door of the customers living in houses on in apartments with ease and convenient. The journey of the package may start from a package delivery warehouse of a courier company. The package may be assigned to the corresponding zone for delivery and the corresponding route and loaded onto a driverless delivery vehicle of a driverless delivery vehicle network. Once the package is assigned to a corresponding route, a gig-worker based computer network may contact for a parcel package receiver via his/her computing device deliver the parcel package based on a priority list. The parcel package receiver with top priority is buyer, if she/he is at home, she/he can pick up their own parcel package. The second top priority are people with the same address, such as housemate, as she/he may receive and take the package directly into the house. The gig-worker based computer network may include a second group that may also include preapproved gig workers that the customer has screened and pre-selected. The other possible gig workers may be people who live in that area, the closer the better as that person will need to travel to get to a meeting point and then to the customer's home. The gig-workers may also be contract workers working for local contract company. Based on the priority list, the gig workers may be contacted and the worker can start to accept or deny the delivery through their computing device. The parcel package may be scanned and information may be loaded so the gig-worker based computer network may know which package is in which locker on which vehicle. The driverless delivery vehicle may have a locker style layout that may allow parcel package to be individually secure and individually release to the correct parcel package receiver after the parcel package receiver verifies their identity. The driverless delivery vehicle may be drive to a predetermined meeting junction to meet the parcel package receiver. The parcel package receiver may now need to verify themselves to have the parcel package released. The verification may be done with an encrypted barcode on their smartphone or handheld device and or facial recognition. Once the identity of the parcel package receiver is verified, the corresponding locker may automatically be opened and the parcel package receiver may retrieve the package for delivery. Once the parcel package is retrieved from the driverless delivery vehicle, the parcel package receiver may now make their way to the customers' front door to make the delivery. The parcel package receiver may knock on the door to see if there is anyone at the house, if not the parcel package receiver may place the package into a parcel safe box, and lock and secure the parcel package to avoid parcel package theft. Further, if the safe box may not be available the parcel package can be hidden. Furthermore, the parcel package receiver may send intimation to the gig-worker based computer network about the successful delivery of the parcel package by, for example taking a photo of the delivered parcel package for sending back to the gig-worker based computer network and recorded to confirm delivery. The system may send a notification to all involved as the delivery has been completed. The system may allow the courier company to use driverless vehicles to cut costs and also using very affordable, reliable labor to make the final delivery of the parcel package with no major investment in hardware like robot and drones and expensive full-time labor.

The system 1000 and a method 2000 for delivering parcel packages 10 at doorsteps will now be described in conjunction with FIGS. 1 to 13, in accordance with an exemplary embodiment of the present disclosure. FIG. 1 illustrates a system 1000 for delivering parcel packages 10, in accordance with an exemplary embodiment of the present disclosure. As seen in FIG. 1, the system 1000 includes a package delivery management unit 100, a driverless delivery vehicle network 200 and at least one gig-worker based computer network 300.

The package delivery management unit 100 may be adapted to sort the parcel packages by a corresponding zone based on corresponding route of the parcel packages. The package delivery management unit 100 may define a predetermined meeting junction 20 corresponding to the route of the parcel packages. In one embodiment, the package delivery management unit 100 may be configured in a package delivery warehouse 30. The package delivery warehouse 30 may include a specified zone, whereby the parcel packages are grouped to be delivered based on categorization of the parcel packages by the corresponding zone for the corresponding route.

Further, the driverless delivery vehicle network 200 may include one or more driverless delivery vehicle 202. The driverless delivery vehicle 200 may be adapted to receive the parcel packages 10 from the corresponding zone based on the corresponding route of the parcel packages 10 to enable the drop of the parcel packages 10 at the predetermined meeting junction 20. In one example embodiment, the driverless delivery vehicle 202 may include an authentication module 206.

The at least one gig-worker based computer network 300 may be communicably coupled to the driverless delivery vehicle network 200. The gig-worker based computer network 300 may include a plurality of computing devices 302 and a gig-worker based management unit 304. The plurality of computing devices 302 may be associated with a plurality of parcel package receivers 40. The plurality of computing devices 302 may be categorized based the types of plurality of parcel package receivers 40, which includes buyers, buyer housemates, and one or more gig-workers. Each of the plurality of computing devices 302 comprises an identification module 306. Further, in one embodiment of the present disclosure, the gig-worker based computer network 300 may also define the predetermined meeting junction 20 corresponding to the route of the parcel packages alone or in coordination with the package delivery management unit 100. Furthermore, in one another embodiment, an independent junction determining module (not shown in FIGS.) may be incorporated in the system 1000 that may be capable of defining the predetermined meeting junction 20 corresponding to the route of the parcel packages alone or in coordination with the package delivery management unit 100 and the gig-worker based computer network 300.

Further, the gig-worker based management unit 304 may include a priority defining and prioritizing module 308 and a communication receiving and sending module 312. The priority defining and prioritizing module 308 may define a priority list 310 of the plurality of computing devices 302 based on the type of the plurality of parcel package receivers 40. Further, the communication receiving and sending module 312 may be configured to the driverless delivery vehicle network 200 to receive details related to the parcel packages. Furthermore, the communication receiving and sending module 312 may also be configured to the plurality of computing devices 302 to send the details related to the parcel packages 10 on the plurality of computing devices 302 based on the priority list 310.

In one embodiment, the parcel packages may be received by a priority parcel package receiver from the plurality of parcel package receivers 40 defined on the priority list 310 at the predetermined meeting junction 20 based on authentication by the authentication module 206 to the identification module 306 or to the plurality of parcel package receivers 40.

In one example embodiment, the driverless delivery vehicle 202 may include one or more lockers 203 to receive the parcel packages 10. The driverless delivery vehicle 202 may itself be locker-styled driverless delivery vehicle. Each such locker 203 may include the authentication module 206. The authentication module 206 may be including, but not limited to, a bar code scanner or a password security module, a facial or a biometric recognition module. Where the authentication module 206 is the facial or biometric recognition module, the plurality of parcel package receivers 40 is identifiable by the authentication module 206. Further, where the authentication module 206 may be the bar code scanner or the password security module, the parcel package receivers 40 may also be identifiable via the identification module 306 incorporated in each of the plurality of computing devices 302, which in one embodiment may include one of an encrypted barcode or messages/password-based system, or an App-based module comprising the encrypted barcode or the messages/password-based system.

In one example embodiment, the plurality of computing devices 302 may be categorized based the types of plurality of parcel package receivers 40 including buyers, buyer housemates, and one or more gig-workers.

In one embodiment, the priority list 310 may be defined based on one or more factors including proximity of one of the plurality of parcel package receivers 40 from the predetermined meeting junction 20, or buyers of the package, or buyer housemate of the package. Based on the one or more factors, the priority list 310 is created and messages are sent by the communication receiving and sending module 312 on to the plurality of computing devices 302. The computing device of the buyer of the parcel package among the various parcel package receivers 40 may be on the top priority in the priority list 310. Based on that, a first message of the messages by the communication receiving and sending module 312 is sent on to a computing device of the plurality of computing devices 302 corresponding to a parcel package receiver 40 of the plurality of parcel package receivers 40 who is on the top of the priority list 310. Further, based on acceptance or denial by the parcel package receiver 40 who is on the top of the priority list 310, the communication receiving and sending module 312 is adapted to send subsequent messages to subsequent parcel package receivers 40 of the plurality of parcel package receivers 40 based on the receive the priority list 310. For example, the communication receiving and sending module 312 may send the message related to the parcel packages 10 on the computing devices 302 of the buyer. The message may include about delivery date, time and the predetermined meeting junction 20 including a particular place for delivery of the parcel package 10. The buyer may choose to accept the message to pick-up the package herself/himself or he may choose to deny the message. In case of the denial, the communication receiving and sending module 312 may send the message to subsequent parcel package receiver 40 in the priority list 310, and so forth.

In one embodiment, the identification module 306 of the computing device of the plurality of computing devices 302 corresponding to the parcel package receiver 40 of the plurality of parcel package receivers 40 is configured to send a confirmation of delivery of parcel packages to the gig-worker based management unit 304.

In one embodiment, the system 1000 may include a safe box 400 in front of a house or a flat of an apartment, or a safe box 400 in apartment to delivery of the package in the safe box 400. In one embodiment, the safe box 400 may include an accessing module 410 to be accessed by the parcel package receiver 40 to keep the parcel package in the safe box 400.

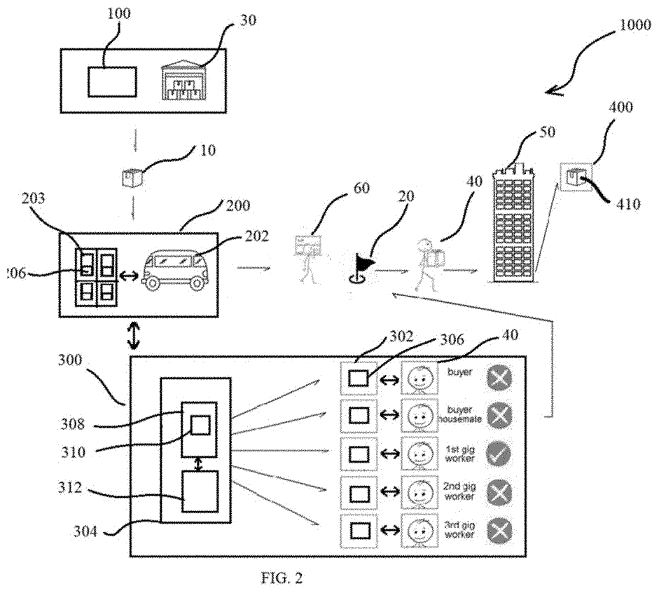

Referring now to FIG. 2, a system 1000 for delivering parcel packages 10 is illustrated in accordance with another exemplary embodiment of the present disclosure and will be described in conjunction with FIG. 1. Embodiments of FIG. 2 is related to a limited access building, which may be a challenge for regular parcel package delivery personnel 60, as such parcel package delivery personnel has an extra hurdle to clear to reach the customers' front door. Further, embodiments of the FIG. 2 also include the delivery vehicle network 200 having at least one delivery vehicle with a driver, who may also act as the parcel package delivery personnel. Such parcel package delivery person using his/her computing or hand-held device may communicate with the parcel package receiver 40 on her/his computing device 302 for meeting at the predetermined meeting junction 20 for delivery of the parcel packages 10. Other step may be similar to the system 100 as described in FIG. 1, and have exclude herein for the sake of brevity of the specification.

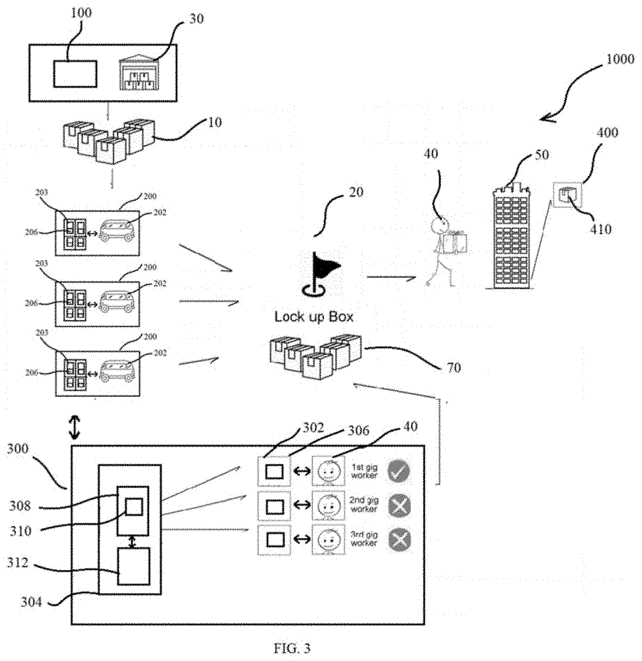

Referring now to FIG. 3, a system 1000 for delivering parcel packages 10 is illustrated in accordance with another exemplary embodiment of the present disclosure and will be described in conjunction with FIG. 1. Embodiments of FIG. 3 is related to batched building delivery, whereby independent couriers may be batched and delivered. Further, embodiments of the FIG. 3 also include the delivery vehicle network or driverless delivery vehicle network 200 having at least one delivery vehicle with a driver or at least one driverless delivery vehicle, who may also act as the parcel package delivery personnel. Such parcel package delivery person may store the parcel packages 10 in a lock-up box 70 at the predetermined meeting junction 20 for delivery of the parcel packages 10, thereafter using his/her computing or hand-held device may communicate with the parcel package receiver 40 on her/his computing device 302 for collecting the parcel packages 10 from the lock-up box 60 at the predetermined meeting junction 20. Here the parcel package receiver 40 may include only one or more gig-workers and not the buyers or the buyer housemates. Other step may be similar to the system 100 as described in FIG. 1, and have exclude herein for the sake of brevity of the specification.

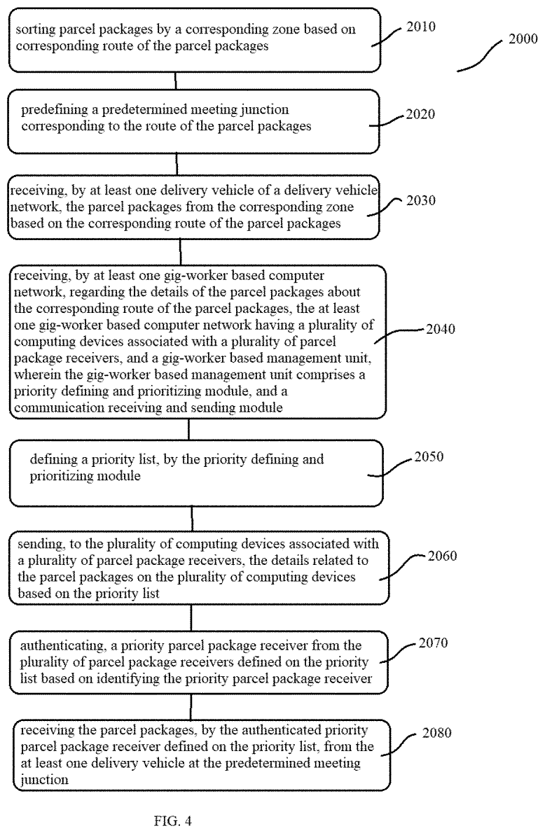

Referring now to FIG. 4, a flow chart 2000 illustrating a method for delivering parcel packages at doorsteps will be described in conjunction with FIGS. 1 to 3. The method, at 2010, comprise sorting parcel packages by the corresponding zone based on corresponding route of the parcel packages 10. Further, at 2020, the predetermined meeting junction 20 corresponding to the route of the parcel packages is predefined. At 2030, the parcel packages from the corresponding zone based on the corresponding route of the parcel packages is received by at least one driverless delivery vehicle 202 of the driverless delivery vehicle network 200. At 2040, the method includes receiving, by at least one gig-worker based computer network 300, regarding the details of the parcel packages about the corresponding route of the parcel packages. As described herein above, the at least one gig-worker based computer network 300 includes the plurality of computing devices 302 associated with the plurality of parcel package receivers 40, and the gig-worker based management unit 304. The gig-worker based management unit 304 includes the priority defining and prioritizing module 308, and the communication receiving and sending module 312. There are excluded herein to avoid repetition and for the sake of brevity. Further, at 2050, a priority list is defined by the priority defining and prioritizing module 308, as described herein above. At 2060, sending, to the plurality of computing devices 302 associated with a plurality of parcel package receivers 40, wherein the details are related to the parcel packages on the plurality of computing devices 302 based on the priority list 310. At 2070, authenticating, a priority parcel package receiver from the plurality of parcel package receivers 40 defined on the priority list 310 based on identifying the priority parcel package receiver. Moreover, at 2080, receiving the parcel packages, by the authenticated priority parcel package receiver defined on the priority list 310, from the at least one driverless delivery vehicle 202 at the predetermined meeting junction 20.

In one embodiment, the method further includes categorizing the plurality of computing devices 302 based the types of plurality of parcel package receivers 40 including buyers, buyer housemates, and one or more gig-workers.

In one embodiment, defining the priority list 310 further includes defining the priority list 310 based on one or more factors including proximity of one of the plurality of parcel package receivers 40 from the predetermined meeting junction 20, or buyers of the package, or buyer housemate of the package. Based on the one or more factors, the priority list 310 is created and messages are sent by the communication receiving and sending module 312 on to the plurality of computing devices 302.

In one embodiment, the method further includes sending a first message of the messages, by the communication receiving and sending module 312, on to a computing device of the plurality of computing devices 302 corresponding to a parcel package receiver 40 of the plurality of parcel package receivers 40 who is on the top of the priority list 310, wherein based on acceptance or denial by the parcel package receiver 40 who is on the top of the priority list 310, the communication receiving and sending module 312 is adapted to send subsequent messages to subsequent parcel package receivers 40 of the plurality of parcel package receivers 40 based on the receive the priority list 310.

In one embodiment, the method further includes, sending a confirmation of delivery of parcel packages to the gig-worker based management unit 304, wherein the confirmation of delivery of the parcel packages comprises one of sending a photograph of the delivery of the parcel packages or sending a text message of the delivery of the parcel packages by the plurality of parcel package receivers 40.

In one embodiment, the method further includes delivering of the package in the safe box in front of a house 50 or a flat of an apartment 50, or a safe box 400 in apartment, wherein the safe box 400 comprises an accessing module 410 to be accessed by the parcel package receiver 40.

The term ‘parcel package receivers’ or the term ‘package receivers’ may include customers who orders the package, peers or mate or anybody know to the customers or gig workers and such terms may be alternatively herein to describe various embodiment of the present disclosure.

Referring now to FIG. 5, a block diagram 4000 illustrating a method for delivering parcel packages is shown, in accordance with an exemplary embodiment of the present disclosure. In the present embodiment, the courier 4005 receives a parcel package for delivery and process to scan the information with their handheld or phone application 4010. The information is then entered into a customer database 4020 to see if the customer has a Gig walker account or ID is will allow the courier know if the Gig workers is pre-approved Gig workers. A package information may be entered into a package database 4030. The customer and package date may later be process in the delivery database 4040 so a route can be planned delivery in next few days. With the route in place, a message may go out to the customer on the gig worker database 4050 about the delivery and to check whether or not the customers are available at home to receive the package. If the customer is available the process ends. If the customer is not available, gig workers are messaged about the potential gigs in their area and a gig worker is selected from the replies and is depicted by a block 4070. Info is than forwarded about the package meet up location and the vehicle and gig workers meet at the determined location and is depicted by a block 4080. Worker verifies their identity and package is release the delivery and is depicted by a block 4090. Further, photos are taken to confirm completion of the delivery and is depicted by a block 4095.

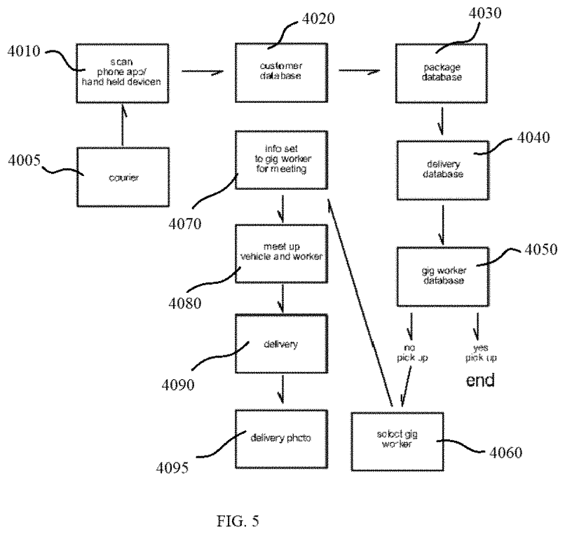

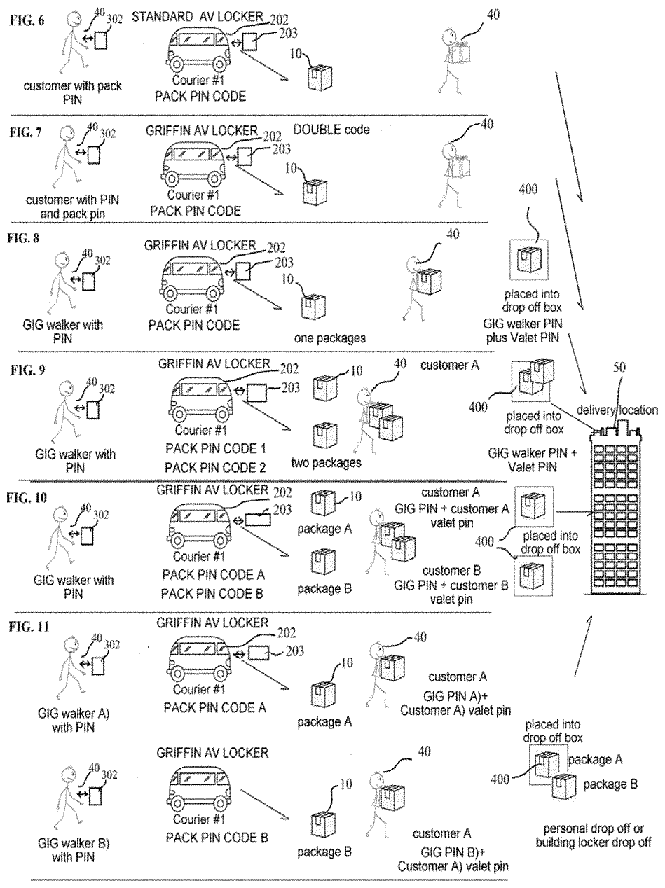

Referring now to FIG. 6, which illustrates is a standard locker delivery where the parcel package receiver 40 would pick up the parcel package 10 from the delivery vehicle 202, which in this present embodiment is an autonomous driving locker truck with the standard single pin code that may be received on the computing device 302 of the parcel package receiver 40, such as the customers. This is the typical parcel package pick up off one code for one package. The pack pin code is the security number use to retrieve the package. The code may be a number of digits or a bar code. The parcel package receiver 40 would insert the pack pin code or scan the bar code in the locker or in the machine, such as locker 203, to retrieve the parcel package 10. The machine or locker would release the corresponding parcel package. The parcel package receiver 40 retrieves that package and the transaction is complete. Anyone with the pack pin code or bar code can retrieve the parcel package 10. This may also be typically done based on authentication by the authentication module 206 to the identification module 306 or to the plurality of parcel package receivers 40, as described above. This system is suitable for parcel package 40 only to retrieve.

Referring now to FIG. 7, customers with a personal secret identifying PIN on his computing device 302, termed herein as the Customer Pin and the Package (pack) Pin. Such PIN may be a number that customer selects like a password, which is easy for them to remember and use, easy for the customer, but hard for anyone else. The package pin code may be a number (or scannable barcode) generated and assigned by the network to the package to retrieve, this is very typical of the current numbers used currently sent to the customers. The customer would enter both their customer pin and the assigned package pin code to retrieve that package. This system would make stealing both codes a lot more difficult as (the customer Pin and the package pin) are from two different sources and located in two different systems. The network would identify the customer by the personal identifying PIN, (you can think of it as a login) and the pack pin code would act like a password in this case. The gig network has assigned the package a pack pins and matched the package to the customer, so the network would know what would be a match. The both pins are needed to be entered correctly to retrieve the correct package. If either pin is incorrect, the package will not be released. The pack pin only offers one time access, once the pack pin is used to retrieve the package the pack pin is deactivated and no longer effective. The Pins can be entered in to specially designed keypad locks or a phone app or an input device on the safe locker which in turn is connected the main network 200 that tracks the packages and has all the pin matches.

Referring now to FIG. 8, the double pin start to show its advantage in this situation of a gig worker 40 retrieving and delivering the parcel package 10. The gig walker 40 will have their own personally selected gig walker pin. The package parcel will have a pack pin code assigned to the package by the network 200. To retrieve the correct parcel package 10, both codes are to be entered to retrieve the package, as described. The codes/pins may not be limited to barcodes, or code or anything that can be scanned or input digit on a keypad that can do secretive. A combination of the two inputs scanned or input is acceptable. So far, the situation is very similar to the customer package pick up scenario as illustrated in FIG. 7. The gig worker 40 will now need to deposit the package into a package locker 400 to avoid thieves and porch pirates. The package locker 400 is any device that securely hold the package. The package locker 400 would typically be a box or a bag with a lock to close and secure the package. The gig worker will have to enter in their Gig Walker Pin and the Valet code using his computing device 302 to open the lock and the locker to insert the package. The valet pin is the locker code assigned by the customer which is given to the delivery person and gig walkers as part of the access code. The double code has a number of advantages, first is the entering of the gig walker code confirms who access the safe and confirms the correct person is entering, the code is like the gig walkers password while the valet pin is the login. The gig walker should not share their gig walker password with anyone. The second is the gig walkers code may not be used without the pre-approved from the network. So, a person may know the valet code but without preapproval of the gig walker pin, the valet code would not work. Now the valet code acts like the login and the gig walker pin acts like the secret password. Once the gig walker uses the matching codes to open the drop off box and deposits the package, the gig walker access to re-enter the package safe is no longer possible as the matching code have expired. The valet pin is sent to the gig walker by the customer via text and email as the customer employs the gig walker. The valet pin would be more widely known as all delivery personnel who accessed the box safe 400 in the pass would know it, that is why the gig walker pin with matching valet pin verification on the network will keep the parcel package safe.

Referring now to FIG. 9, a gig walker 40 with a gig pin number will be picking up two parcels for the same customer. The gig walker 40 with gig pin also has two pack pin codes for the two packages. This will allow the truck locker 203 or parcel package locker 203 to know who is picking up the packages as the gig walker 40 has entered in their gig walker pin. The pack pin code will tell the machines which package to release first. This is important as the locker 203 truck should only release one package at a time as releasing two packages at one time allows the gig walker 40 to retrieve to receive one package but the second package is exposed and it may be stolen. This is extra important as a busy gig walker 40 may be picking up 2-10 packages at one time. If the packages 10 are retrieved one at a time, the packages can be all secured. The network 200 will tell the locker that the walker pin and the package code must match as the network is expecting a matching set of combination of a Package pin and Gig walker Pin. Every package in the gig system has assigned a gig walker to perform the delivery and every package has an assigned a pack pin number. The gig walker must enter both their gig walker pin and assigned pack code 1 to retrieve the first package from the locker 203, as described. Once the first package 10 has been retrieved safely and secured, it is time for the second package 10, now repeat the process again, as described. Enter the gig walker pin and the package code 2 and retrieve the 2nd package. Now the access log has recorded that the gig walker has retrieve two packages with their personal Gig walker PIN and matching Pack pin. Once the gig walker has both packages, the gig walker can deliver the packages to the 2 customers, this can be personally handing the package to the customer or deposit both packages into the customer's parcel safe. To open the parcel, drop off box or safe box 400, the gig walker will enter the gig walker pin and the valet pin. The valet pin is used by the customers to allow the gig walkers to access the drop off box. The gig walker pin must be preapproved to open the drop off box. The entering of the gig walker pin will log who had access to the box. Once accessed the parcel drop off box, the gig walker pin would be removed from the preapproved list and it would not be able the open the drop off safe till it is approved again. This double pin is ideal, the valet pin will remain the same, the customers master pin will be the master pin and valet pin but the package pin would change on a package-by-package bases. The two-part pin protects the gig walker as they are responsible for the package delivery and once assigned only the gig walker has both the gig walker pin and the package pin needed to retrieve the package pin. Even the customer/owner cannot retrieve the package, unless they cancel the assignment to the gig walker and if that happens the gig walker is not responsible for the delivery of the package or accept the package.

Referring now to FIG. 10 a gig walker 40 with pin will pick up two packages 10, here as shown in FIG. 10 as a package A and a package B. The gig walker 40 has been sent both Pack pin Code A and Pack pin code B to allow him to retrieve the two packages A and B for their respective customers. Gig walker 40 goes to the EV locker truck/ unit and enter their Gig walker Pin with the first pack pin code A, the first package is release to the gig walker and the package A is retrieved and secured. The Gig walker 40 enters his gig walker pin again and the second Pack Pin Code B for the second package B to be released. The second package B is now released and secured. The gig walker 40 now takes both packages A and B to make the deliveries. The gig walker 400 goes to customers A's drop off box and enters his Gig walker Pin and the customers A valet pin as usual. The network 200 has arranged the gig and the Customer A to work together and is expecting the gig worker to enter in their Pin and the Customers A Valet pin to open the lock. If that does not happen the safe will not open. With the correct gig walker pin and correct valet pin the safe will open.

After the first delivery is completed the gig walker 40 will go to the second parcel safe. The gig walker now enters in their gig walker pin and customers B valet pin to access the customers B's drop off box of safe box 400. In this case of the customers A and B drop off box pin is more common knowledge to other gig walkers so the safe box pin, so it would act more like the login and the gig walker pin will act more like the password as the gig walker is no out there and he should not be giving away his pin number. The access log will record who entered the drop off box. This feature is to protect the owner of unauthorized access to their but it also protects the gig walker from people stealing his delivered package as they did not use his gig walker pin. So, we know who is opening what box/safe. With the double two part pin the security is a lot higher.

Referring now to FIG. 11, and will be described in conjunction to above figures, in this scenario, the GIG walker A and Gig walker B are both will be picking up and dropping off packages into customers A's drop off safe. Both gig walkers enter their gig walker pin and the pack pin code to retrieve their respective packages. Gig walker A, goes to the drop off box and enters in their Gig Walker Pin and the valet pin. The Gig walker A deposits the package into the safe and secures the package. Gig walker B turn to deposit the package. Gig walker B enters in their gig walker pin and valet pin. The gig walker B can now deposit their package into the drop off box. Now there are two packages in the safe. The major benefit of the double pin. We know both gig walker accesses the safe as it is recorded in the log as both gig walkers logged in. The gig walkers are using the same valet pin as the common login as both the gig walkers know the login. And they will use their personal private Gig Walker pin as the password as that is not shared. Their passwords identify each walker. The major security risk is this scenario is the second gig walker as they have access to the first package. The fact that the second gig walker logged-in and we know they are there in the safe reduces the chance of the first package being stolen by the second gig walker. The first walker would have also login in and that would decrease the chances of them stealing their own package and try to blame the second gig walker as the first gig walker does not know if there is a second gig walker that day to blame. The second gig walker would not steal the first packages as the first would not steal their own package as they have no one the blame. Everyone keeps everyone in check and balance. The requirement of a delivery photo would also go a long way of reducing internal theft. The access logs will record everything and it would deter the gig walker of stealing any of our gig secured packages and steal other low hanging unsecure packages.

The two-pin system is a good system of check and balances to reduce theft and increase accountability in the gig walkers. It also decreases the chance of a hacking as the “login and password combinations” are always changing and there is also a log of who accessed the locker truck unit and drop off boxes.

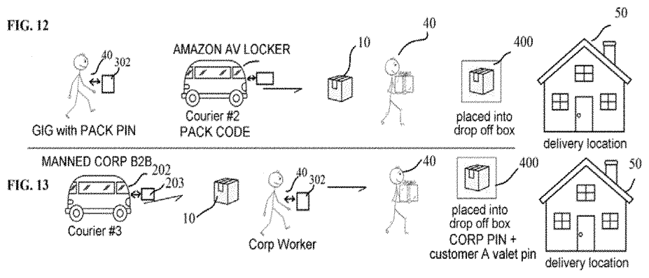

Referring now to FIG. 12, manned courier delivery is illustrated utilizing the system 1000. The driver/delivery person 40 would take the package 10 from the back of their vehicle 40 and place the package into the drop off box 400. To have access to the drop off box 400, the driver will enter in their corp pin or (corporation pin) and the customer's valet pin to open the drop off box. The corp pin can be one number for the entire corporate if the organization is not too big, share passwords are discouraged. Individual employee personal identification number (PIN) would be ideal, as this is better for tracking and logging access. This process would be easy to implement.

Referring now to FIG. 13, return package pickup is illustrated utilizing the system 1000. The customer 40 may have purchased something that they do not like so a return is required. This system 1000 allows a gig walker 40 to pick up the package 10 from the package safe 400 with the gig walker PIN and the valet code to access the return package and make their way back to the locker truck. The locker truck 202 will have a preassigned slot for the package to accept the return. The Gig walker 40 will enter their Gig walker pin and the package pin and the assigned slot will open. Once inserted the gig walker will close the slot and this part of the return in complete.

The present disclosure is advantageous in providing a system and a method for delivering parcel packages which may enable delivery of the packages in gated communities or in entry-limited buildings like high rises buildings. The present disclosure is advantageous in providing a system and a method for delivering parcel packages which may enable the delivery vehicles with or without driver in getting the mail parcel packages from the back of the delivery vehicle and to delivery of the package to the customers door cost effectitve and secure manner. The Gig Walker coordinating network system combined with the driverless vehicle technology will allow the courier to require almost no delivery labor with no expensive robots or drones after the driverless vehicle leaves warehouse. The courier companies that have this technology advantage will have a huge business method advantage over their competitors. The courier will also make their operation good a lot smoother and more predictable. This is significantly more of an advantage the driverless technology on its own. The gig Walker method and system with driverless technology will transform the courier business as they can use driverless vehicle with almost no limit while their competitors are dramatically limited to how they can use the driverless vehicles.

The present disclosure is advantageous from the perspective of the Gig walker in providing such gigs like stay-at-home parents, retirees, students, limited mobility person to make a little extra money without any tools like a car or specialized skill. Just a little walking and delivering a package to a neighbor. Potential gig walkers would apply to enter the program via a application form, references and a possible back ground check maybe required. The gig walker would be contract workers. The once contracted, the gig walker can put restrictions on packages like no heavy packages, no oversize package sizes as it may be unsafe for some to carry the package. The gig walker will be assigned a map location in the gig network and any gig inside that area the gig walker would be able to accept the gig or not. When a gig in the area is available, the gig network will select a number of gig walker to apply for the gig. The network will send the selected group a text about the location and time of the gig, and the walkers can accept or deny the gig. Of the accepted walkers, the gig network will assign one gig worker as the primary and one as the secondary backup. A text will be sent from the gig network to the primary and backup that they are selected and the text will also indicate the meeting location. A reminder text will be sent to the primary and backup of the 5 minutes before meeting up about the time and location to meeting and delivery address. Once the 5-minute warning has been received the gig walker has enough time to walk to the meeting point to retrieve the package to make a delivery. Once the parcel is dropped off the gig walker will take a photo and upload the photo into the system to confirm delivery.

The present disclosure is advantageous from the perspective of the customer in providing the customer who ordered a product online but cannot or does not want to wait at home to receive the package. The customer can place their order and sign up for the gig walker. The customer will receive a text asking if they will be home on the delivery date and available to receive the package and the customers responds with a yes or no (a no reply is a no) If the answer is a no, the gig network will contact any preselected gig walker and any gig walkers in the customers area about the gig. The contacted gig walkers can deny or accept the gig. Later on, a gig walker and a backup will be selected to complete the task. Preselected gig walkers will have priority. The customers can also install a package safe and so when the package is delivered it can be secured. The customer can now order online and expect that package to be at their home secure every time. This will eliminate stolen packages, second and third delivery attempts and picking up parcels at the couriers pick up points. The customer can do this for a small fee which most people are will to pay to save time and hassle. The courier can also pay a small fee also as this will also make their operation good a lot smoother and more predictable.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A system for delivering parcel packages at doorsteps, the system comprising:
a package delivery management unit adapted to sorting the parcel packages by a corresponding zone based on corresponding route of the parcel packages, wherein the package delivery management unit defines a predetermined meeting junction corresponding to the route of the parcel packages; and
a delivery vehicle network having at least one delivery vehicle, wherein the at least one delivery vehicle is adapted to receives the parcel packages from the corresponding zone based on the corresponding route of the parcel packages to drop the parcel packages at the predetermined meeting junction, the at least one delivery vehicle having an authentication module; and
at least one gig-worker based computer network communicably coupled to the delivery vehicle network, the at least one gig-worker based computer network having:
a plurality of computing devices associated with a plurality of parcel package receivers, wherein the plurality of computing devices is categorized based the types of plurality of parcel package receivers, wherein each of the plurality of computing devices comprises an identification module or the plurality of parcel package receivers is identifiable by the authentication module, and
a gig-worker based management unit having,
a priority defining and prioritizing module defining a priority list of the plurality of computing devices based on the type of the plurality of parcel package receivers,
a communication receiving and sending module configured:
to the delivery vehicle network to receive details related to the parcel packages; and
to the plurality of computing devices to send the details related to the parcel packages on the plurality of computing devices based on the priority list,
wherein the parcel packages are received by a priority parcel package receiver from the plurality of parcel package receivers defined on the priority list at the predetermined meeting junction based on authentication by the authentication module to the identification module or to the plurality of parcel package receivers.

2. The system of claim 1, wherein the package delivery management unit is configured in a package delivery warehouse, the package delivery warehouse having a specified zone, whereby the parcel packages are grouped to be delivered based on categorization of the parcel packages by the corresponding zone for the corresponding route.

3. The system of claim 1, wherein the at least one delivery vehicle comprises one or more lockers to receive the parcel packages, wherein each of the one or more lockers includes the authentication module, and wherein the authentication module comprises at least one of a bar code scanner module and a facial or biometric recognition module, and wherein where the authentication module is the facial or biometric recognition module, the plurality of parcel package receivers is identifiable by the authentication module.

4. The system of claim 1, wherein the identification module in each of the plurality of computing devices comprises one of an encrypted barcode or messages/password-based system, or an App-based module comprising the encrypted barcode or the messages /password-based system.

5. The system of claim 1, wherein the plurality of computing devices is categorized based the types of plurality of parcel package receivers including buyers, buyer housemates, and one or more gig-workers.

6. The system of claim 1, wherein the priority list is defined based on one or more factors including proximity of one of the plurality of parcel package receivers from the predetermined meeting junction, or buyers of the package, or buyer housemate of the package, wherein based on the one or more factors, the priority list is created and messages are sent by the communication receiving and sending module on to the plurality of computing devices.

7. The system of claim 6, wherein a first message of the messages by the communication receiving and sending module is sent on to a computing device of the plurality of computing devices corresponding to a parcel package receiver of the plurality of parcel package receivers who is on the top of the priority list, wherein based on acceptance or denial by the parcel package receiver who is on the top of the priority list, the communication receiving and sending module is adapted to send subsequent messages to subsequent parcel package receivers of the plurality of parcel package receivers based on the receive the priority list.

8. The system of claim 1, wherein the identification module of the computing device of the plurality of computing devices corresponding to the parcel package receiver of the plurality of parcel package receivers is configured to send a confirmation of delivery of parcel packages to the gig-worker based management unit.

9. The system of claim 1 further comprising a safe box in front of a house or a flat of an apartment, or a safe box in apartment to delivery of the package in the safe box, wherein the safe box comprises an accessing module to be accessed by the parcel package receiver.

10. The system of claim 1, wherein the delivery vehicle network is a driverless delivery vehicle network having at least one driverless delivery vehicle.

11. The system of claim 1, wherein the delivery vehicle network is a delivery vehicle network having at least one delivery vehicle with a driver.

12. A method for delivering parcel packages at doorsteps, the method comprising:
sorting parcel packages by a corresponding zone based on corresponding route of the parcel packages,
predefining a predetermined meeting junction corresponding to the route of the parcel packages;
receiving, by at least one delivery vehicle of a delivery vehicle network, the parcel packages from the corresponding zone based on the corresponding route of the parcel packages;
receiving, by at least one gig-worker based computer network, regarding the details of the parcel packages about the corresponding route of the parcel packages, the at least one gig-worker based computer network having a plurality of computing devices associated with a plurality of parcel package receivers, and a gig-worker based management unit, wherein the gig-worker based management unit comprises a priority defining and prioritizing module, and a communication receiving and sending module;
defining a priority list, by the priority defining and prioritizing module;
sending, to the plurality of computing devices associated with a plurality of parcel package receivers, the details related to the parcel packages on the plurality of computing devices based on the priority list;
authenticating, a priority parcel package receiver from the plurality of parcel package receivers defined on the priority list based on identifying the priority parcel package receiver;
receiving the parcel packages, by the authenticated priority parcel package receiver defined on the priority list, from the at least one delivery vehicle at the predetermined meeting junction.

13. The method of claim 12, further comprising categorizing the plurality of computing devices based the types of plurality of parcel package receivers including buyers, buyer housemates, and one or more gig-workers.

14. The method of claim 12, wherein defining the priority list further comprises:
defining the priority list based on one or more factors including proximity of one of the plurality of parcel package receivers from the predetermined meeting junction, or buyers of the package, or buyer housemate of the package, wherein based on the one or more factors, the priority list is created and messages are sent by the communication receiving and sending module on to the plurality of computing devices.

15. The method of claim 14, further comprising: sending a first message of the messages, by the communication receiving and sending module, on to a computing device of the plurality of computing devices corresponding to a parcel package receiver of the plurality of parcel package receivers who is on the top of the priority list, wherein based on acceptance or denial by the parcel package receiver who is on the top of the priority list, the communication receiving and sending module is adapted to send subsequent messages to subsequent parcel package receivers of the plurality of parcel package receivers based on the receive the priority list.

16. The method of claim 12 further comprising sending a confirmation of delivery of parcel packages to the gig-worker based management unit, wherein the confirmation of delivery of the parcel packages comprises one of sending a photograph of the delivery of the parcel packages or sending a text message of the delivery of the parcel packages by the plurality of parcel package receivers.

17. The method of claim 12 further comprising delivering of the package in the safe box in front of a house or a flat of an apartment, or a safe box in apartment, wherein the safe box comprises an accessing module to be accessed by the parcel package receiver.

18. The method of claim 12, wherein the delivery vehicle network is a driverless delivery vehicle network having at least one driverless delivery vehicle.

19. The method of claim 12, wherein the delivery vehicle network is a delivery vehicle network having at least one delivery vehicle with a driver.
